(19) United States
(12) Patent Application Publication
(10) Pub. No.: US 2016/0093070 A1
(43) Pub. Date: Mar. 31, 2016

(54) SPACERS OF DIFFERENT SIZES WITHIN SEAL TO LIMIT MOISTURE INGRESS

(71) Applicant: Pixtronix, Inc., San Diego, CA (US)

(72) Inventors: Ji Ma, Haverhill, MA (US); Xianhe Wei, Somerville, MA (US); Eugene Fike, Amesbury, MA (US)

(21) Appl. No.: 14/498,460

(22) Filed: Sep. 26, 2014

(51) Int. Cl. G06T 11/00; B32B 37/12; B32B 37/00; G02B 26/04; B32B 37/18

(52) U.S. Cl. CPC G06T 11/00; G02B 26/04; B32B 37/18; B32B 37/0076; B32B 37/1292; B32B 2037/1253; B32B 2457/20; G06T 2200/28; G06T 2211/00

(57) ABSTRACT

This disclosure provides systems, methods and apparatus for packaging a display device, such as an electromechanical systems (EMS) device, with a seal. In one aspect, the display device includes a seal or sealant surrounding a display region of the display device in contact with and between two substrates. The sealant can include an epoxy matrix with a plurality of first spacers and a plurality of second spacers. In some implementations, the first spacers can be about the same size and define a substrate-to-substrate gap between the two substrates. In some implementations, each of the second spacers can be smaller than the first spacers, where the second spacers have a water vapor transmission rate less than the epoxy.

### TECHNICAL FIELD

This disclosure relates to packaging of electromechanical systems and devices, and more particularly to incorporation of spacers in seals of electromechanical systems and devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

Device packaging can protect the functional units of the electromechanical systems and devices from the environment. A sealant around electromechanical systems and devices can protect the functional units from moisture and environmental contaminants as well as provide mechanical support for system components.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display device. The display device includes a first substrate having a first surface and a second substrate having a second surface opposite the first surface of the first substrate. The display device further includes a sealant positioned around the perimeter of the display device and in contact with and between the first substrate and the second substrate. The sealant includes an epoxy, a plurality of first spacers inside the epoxy and having a size defining a substrate-to-substrate gap between the first substrate and the second substrate, and a plurality of second spacers inside the epoxy. The plurality of second spacers inside the epoxy have an average size less than the size of the first spacers, and the second spacers have a water vapor transmission rate less than the epoxy.

In some implementations, the density of the plurality of second spacers is between about 0.5 wt. % and about 5.0 wt. % of the sealant. In some implementations, the density of the plurality of first spacers is between about 0.1 wt. % and about 1.5 wt. % of the sealant. In some implementations, the second spacers are made of one or more of silica (SiO₂), silicon (Si), silver (Ag), gold (Au), platinum (Pt), titanium (Ti), alumina (Al₂O₃), titanium oxide (TiO₂) and diamond. In some implementations, the sealant has a water vapor transmission rate of less than about 34 g/m²/day across a 1 mm membrane at 60° C. and 90% relative humidity. In some implementations, the display device further includes a display element disposed on the first surface of the first substrate, where the seal encloses the display element. For example, the display element can include a shutter-based light modulator.

Another innovative aspect of the subject matter described in this disclosure can be implemented in a display device. The display device includes a first substrate having a first surface and a second substrate having a second surface opposite the first surface of the first substrate. The display device further includes a means for sealing the display device positioned around the perimeter of the display device and in contact with and between the first substrate and the second substrate. The sealing means include an epoxy, means for defining a substrate-to-substrate gap between the first substrate and the second substrate inside the epoxy, and means for reducing moisture ingress inside the epoxy, where the moisture ingress reducing means have an average size less than the substrate-to-substrate gap defining means and each have a water vapor transmission rate less than the epoxy.

In some implementations, the density of the moisture ingress reducing means is between about 0.5 wt. % and about 5.0 wt. % of the sealing means. In some implementations, the density of the substrate-to-substrate gap defining means is between about 0.1 wt. % and about 1.5 wt. % of the sealing means. In some implementations, the substrate-to-substrate gap defining means are substantially evenly distributed within the epoxy and the moisture ingress reducing means are substantially randomly distributed within the epoxy.

Another innovative aspect of the subject matter described in this disclosure can be implemented in a method of manufacturing a display device. The method includes providing a first substrate having a first surface, providing a second substrate having a second surface opposite the first surface of the first substrate, and forming a seal around a perimeter of the display device in contact with and between the first substrate and the second substrate. The seal includes an epoxy, a plurality of first spacers and a plurality of second spacers. The plurality of first spacers in the epoxy define a substrate-to-substrate gap distance between the first substrate and the second substrate. The second spacers are each smaller than the first spacers and have a water vapor transmission rate less than the epoxy.

In some implementations, the method further includes providing a display element on the first surface of the first substrate, where the seal encloses the display element. In some implementations, the method further includes mixing the first spacers and the second spacers into the epoxy before forming the seal around the perimeter of the display device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3A shows a schematic of a top view of an example display device having a sealant around a perimeter of the display device.

FIG. 3B shows a top view of an example display device having a sealant around a perimeter of the display device.

FIG. 4 shows a cross-sectional view along line A-A of FIG. 3A for the example display device, the cross-sectional view showing the sealant including a spacer.

FIG. 5A shows a cross-sectional view along line B-B of FIG. 3A for the example display device, the cross-sectional view showing the sealant including spacers of the same size.

FIG. 5B shows a cross-sectional view along line B-B of FIG. 3A for the example display device, the cross-sectional view showing the sealant including spacers of different sizes.

FIG. 6A shows a flow diagram illustrating an example process for manufacturing a display device.

FIG. 6B shows another flow diagram illustrating another example process for forming a seal around a perimeter of a display device.

FIGS. 7A and 7B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A display device can be packaged to include a seal between two substrates and surrounding a display region of the display device. The seal or sealant can include an epoxy-based adhesive having at least two types of spacers, such as first spacers and second spacers. In some implementations, the first spacers can include bigger-sized spacers and the second spacers can include smaller-sized spacers that are smaller than the first spacers. The first spacers can have a substantially uniform size to establish a gap or separation between the two substrates. The second spacers may be distributed in the epoxy-based adhesive and can reduce the water vapor transmission rate of the sealant. Both the first and second spacers may be highly impermeable to water and relatively incompressible. In some implementations, the second spacers can have a density between about 0.1 wt. % and about 10 wt. % of the sealant, or between about 0.5 wt. % and about 5.0 wt. % of the sealant, and can have a size between about 1 μm and about 30 μm, or between about 5 μm and about 15 μm. In some implementations, the second spacers may be made of silica. The first spacers may be made of the same material as the second spacers. In some implementations, the first spacers can have a density between about 0.05 wt. % and about 3.0 wt. % of the sealant, or between about 0.1 wt. % and about 1.5 wt. % of the sealant, and can have a size between about 5 μm and about 25 μm, or between about 10 μm and about 20 μm.

Particular implementations of the subject matter described in this disclosure can be implemented to realize one or more of the following potential advantages. The addition of second spacers which are smaller than the bigger-sized gap-defining first spacers can lower the water vapor transmission rate of the sealant including an epoxy-based adhesive. This can reduce moisture from entering into the display device. In some implementations, reducing the amount of moisture entering into the display device can preserve the electrical properties of a fluid and/or limit the effects of stiction in a MEMS display device, which can otherwise cause the display device to fail. Thus, second spacers in the epoxy-based adhesive can improve the lifetime, operation, and performance of the display device.

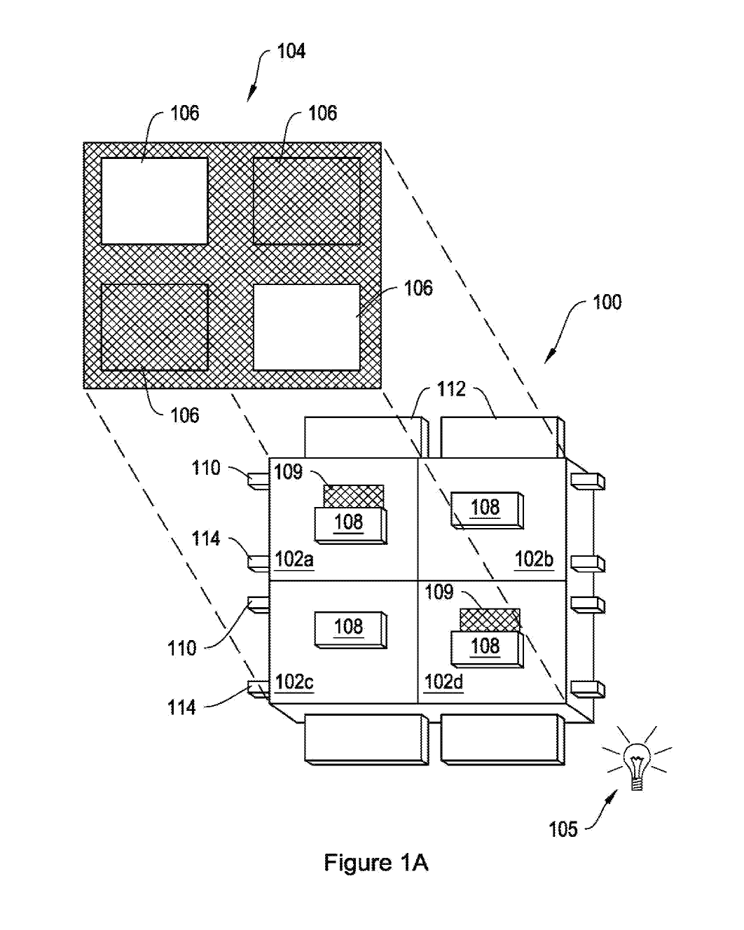

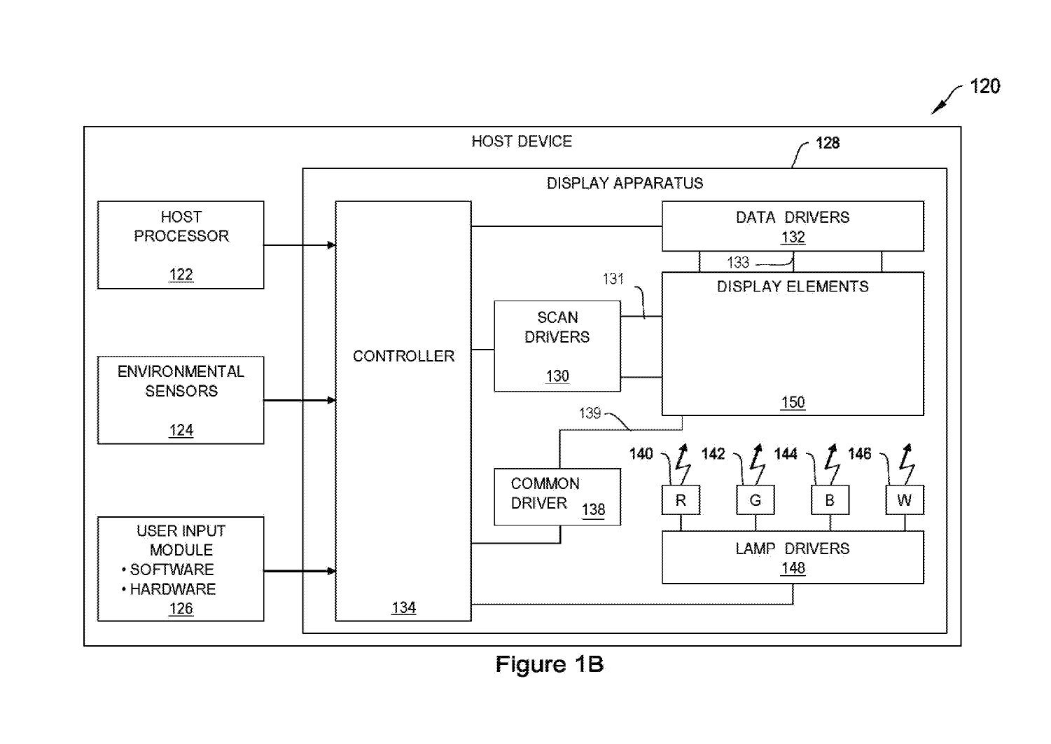

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

In FIG. 1, the reflective properties of pixels 12 are generally illustrated with arrows 13 indicating light incident upon the pixels 12, and light 15 reflecting from the IMOD 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the IMOD 12.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

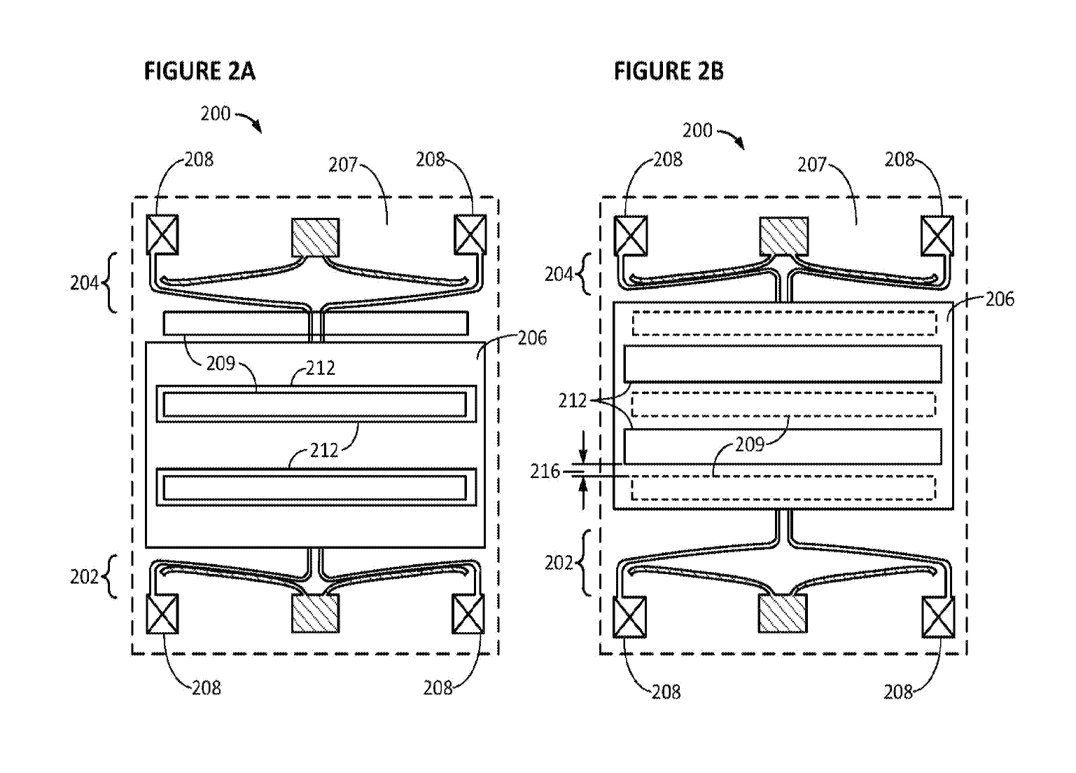

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

Display devices can be packaged to withstand environmental forces and to limit the ingress of moisture and other environmental agents. The ingress of moisture can be a significant reliability concern for display devices. For example, moisture can adversely affect the electrical properties of fluid in shutter-based light modulator displays or cause stiction in other EMS or MEMS-based displays.

Moisture ingress can adversely affect the electrical properties of a fluid in a shutter-based MEMS display device. Without being limited by any theory, the moisture can increase the concentration of charged species in the fluid to create charged areas. For example, the charged areas in the fluid can cause the light modulator to slow down, become attracted or otherwise become stuck to a charged area, thereby adversely affecting the operation of the shutter-based display device. In some instances, if the charge buildup is large enough, the resulting electrostatic forces may pull the light modulator with enough force to bend beams that support the light modulators, thereby rendering the light modulators permanently inoperable.

Moisture ingress also can adversely affect the mechanically moving parts of other EMS or MEMS display devices by causing stiction. Stiction occurs when surface adhesion forces are higher than the mechanical restoring force of the mechanically moving parts. This can cause a movable layer to stick to a substrate or a stationary layer in an EMS or MEMS display device, which can introduce a reliability concern, reduce performance, and reduce the lifetime of the display device.

A display device may limit the ingress of moisture into various device components by providing a seal around a display region of the display device. However, water vapor and other environmental contaminants may still flow through the seal depending on barrier capabilities of the seal. A hermetic seal, such as a glass frit, can substantially prevent water vapor and other environmental contaminants from flowing through the seal. A non-hermetic or semi-hermetic seal, such as an epoxy-based adhesive, may limit water vapor and other environmental contaminants from flowing through the seal by having a low water vapor transmission rate.

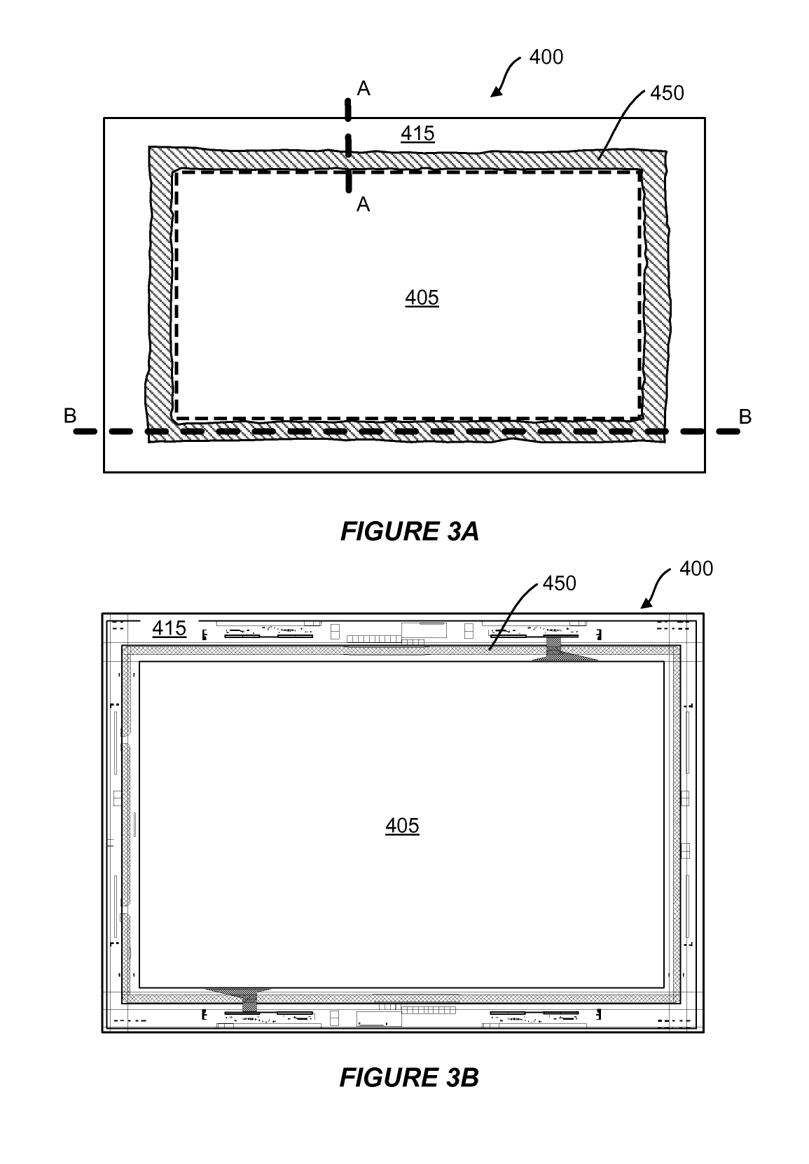

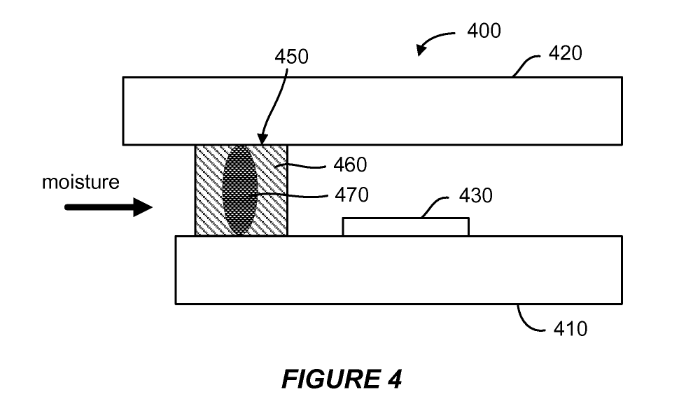

FIG. 3A shows a schematic of a top view of an example display device having a sealant around a perimeter of the display device. FIG. 3B shows a top view of an example display device having a sealant around a perimeter of the display device. FIG. 4 shows a cross-sectional view along line A-A of FIG. 3A for the example display device, the cross-sectional view showing the sealant including a spacer. A sealant 450 may be provided around a perimeter of a display device 400 to seal one or more display elements 430 between a first substrate 410 and a second substrate 420. The sealant 450 may be referred to as a barrier seal or edge seal. The sealant 450 can include an epoxy-based adhesive or epoxy 460. In some implementations, the sealant 450 can include a plurality of first spacers 470 in the epoxy 460. The first spacers 470 can include a plastic, glass, ceramic or other material. The first spacers 470 may constitute particles distributed within the epoxy 460 that are substantially incompressible. As illustrated in the example in FIG. 4, the spacers 470 may define a separation distance between the two substrates 410 and 420. Specifically, the size of the spacers 470 may establish a substrate-to-substrate gap for the display device 400.

In FIGS. 3A and 3B, the sealant 450 surrounds a display region 405 of the display device 400. The display region 405 may include a region through which an image may be displayed and viewed. A non-display region 415 may include a region outside of the display region 405 and may correspond to regions where the sealant 450 and components connecting to display elements 430 may be located. The non-display region 415 may be positioned along a perimeter of the display device 400. In some implementations, the sealant 450 may be continuous and form a ring around the display region 405 of the display device 400.

In FIG. 4, the display device 400 may include a first substrate 410 and a second substrate 420. The first substrate can include a first surface and the second substrate can include a second surface opposite the first surface of the first substrate. Each of the first surface and the second surface may be planar or substantially planar. The first substrate can include a semiconducting or insulating material. The first substrate 410 may include different substrate materials, including transparent materials, non-transparent materials, flexible materials, rigid materials or combinations thereof. For example, the first substrate 410 can include silicon (Si), silicon-on-insulator (SOI), germanium (Ge), silicon germanium (SiGe), silicon nitride (SiN), gallium arsenide (GaAs), gallium arsenide phosphide (GaAsP), indium phosphide (InP), indium tin oxide (ITO), gallium aluminum arsenic (GaAlAs), indium gallium phosphide (InGaP), metals (such as gold (Au), aluminum (Al), titanium (Ti), etc.), polymer resins, silicon carbide (SiC), SiO₂, glass and quartz. In some implementations, the first substrate 410 can include glass. In some implementations, the first substrate 410 may be part of an integrated circuit with one or more active or passive devices formed thereon. In some implementations, the first substrate 410 may be referred to as the aperture plate.

The second substrate 420 may be provided opposite the first substrate 410. The first surface of the first substrate 410 may provide a surface upon which various device components may be built or formed upon. The second substrate 420 may serve as a cover for such device components, where the device components can include the display element 430. The cover of a display device 400 can provide protection for the display element 430 against ambient conditions, such as temperature, pressure, moisture and other environmental conditions. In some implementations, the second substrate 420 may made of the same material as the first substrate 410. For example, the second substrate 420 can include glass. In some implementations, the second substrate 420 may be referred to as a back plate, cover plate, cover glass, back glass or back plane.

The first substrate 410 and the second substrate 420 may be joined by a sealant 450 to form a package structure to enclose the display element 430. The display element 430 can be disposed on the first surface of the first substrate 410. The sealant 450 can enclose the display element 430 in the display device 400. The display element 430 can include an EMS or MEMS-based display element, such as an IMOD or shutter-based light modulator. In some implementations, a cavity may be formed within the enclosure to form a protected space in which mechanical parts of the EMS or MEMS-based display element can move. In some implementations, the cavity may be filled with a fluid. The EMS or MEMS-based display element may be immersed in the fluid. The fluid can serve as a lubricant to facilitate movement of the many movable parts of the EMS or MEMS-based display element. In some implementations, the fluid can have a low coefficient of friction, low viscosity, and minimal degradation effects over the long term. Examples of suitable fluids include, without limitation, de-ionized water, methanol, ethanol and other alcohols, paraffins, olefins, ethers, silicone oils, fluorinated silicone oils, or other natural or synthetic solvents or lubricants.

The sealant 450 may be provided in contact with the substrates 410 and 420 and in between the two substrates 410 and 420. In some implementations, conductive elements or conductive spacers may be provided in the sealant 450 to provide electrical communication between the two substrates 410 and 420. The sealant 450 can include a polymer-based adhesive or an epoxy-based adhesive 460 that may be dispensed and cured to seal the display device 400. A polymer-based adhesive or epoxy-based adhesive 460 may be curable using a thermal, ultraviolet (UV) or microwave cure. One example of a suitable sealant material is a UV-curable epoxy sold by Nagase Chemtex Corporation with a product name XNR5570.

The sealant 450 may protect against moisture ingress into the cavity or fluid-filled cavity of the display device 400. The material of the sealant 450 can be selected according to its water vapor permeability properties and/or outgassing properties. The sealant 450 may provide protection against moisture ingress by including a material having a low water vapor transmission rate. In some implementations, the sealant 450 can include any suitable epoxy 460 having a water vapor transmission rate between about 10 g/m²/day and about 50 g/m²/day as measured at 60° C. and 90% relative humidity across a 1 mm membrane. Limiting moisture ingress can reduce the undesirable buildup of charge in a fluid and/or stiction in EMS or MEMS-based display devices.

The sealant 450 may have a width between about 0.5 mm and about 5 mm, such as between about 1 mm and about 2 mm, covering the non-display region 415 of the display device 400. A wider sealant 450 may provide increased protection against moisture ingress. The sealant 450 may have a thickness or height between about 5 μm and about 25 μm, such as between about 10 μm and about 20 μm. In FIG. 4, the thickness or height of the sealant 450 may be defined by a first spacer 470. The first spacer 470 can define the substrate-to-substrate gap distance between the two substrates 410 and 420 according to a desired separation. In some implementations, the first spacer 470 can define the substrate-to-substrate gap distance between the two substrates 410 and 420 in the non-display region 415 of the display device 400. In some implementations, the first spacer 470 can be distributed in the epoxy 460 of the sealant 450. Thus, the sealant 450 can include the first spacer 470. In some implementations, the first spacer 470 can be fabricated or otherwise formed on the first substrate 410 or second substrate 420 prior to providing the sealant 450. In some implementations, the first spacer 470 can be mixed with the epoxy 460 simultaneous with or after the epoxy 460 is dispensed.

The substrates 410 and 420 may be aligned to make contact with the first spacer 470. The first spacer 470 may be relatively rigid and incompressible so that the space between the substrates 410 and 420 is maintained. In some implementations, the first spacer 470 maintains a minimum cell height or gap height between the two substrates 410 and 420 within a tolerance of about 3 μm or less. The first spacer 470 may be any suitable shape, such as a bead, rod, cylinder, ellipse or sphere. In some implementations, the shape of the first spacer 470 may be a sphere, ellipse or rod-shaped. That way, contact with any of the substrates 410 and 420 may occur at a single point. The rigidity of the first spacer 470 can maintain the minimum cell height or gap height at the display edge between the two substrates 410 and 420 even under compression. In some implementations including the epoxy 460 made of XNR5570, for example, one or more 12 μm-diameter glass spheres may be mixed into the epoxy 460 and serve as first spacers 470.

In some implementations, the first spacer 470 can be made of a plastic, glass, ceramic or other material. In some implementations, the first spacer 470 can include quartz, glass, single crystalline silicon (mono-Si), polysilicon (poly-Si), amorphous silicon (a-Si), silica (SiO₂), silver (Ag), gold (Au), platinum (Pt), aluminum (Al), titanium (Ti), alumina (Al₂O₃), titanium oxide (TiO₂) and diamond. For example, the first spacer 470 may be made of silica. The first spacer 470 may be impermeable to water vapor and provide increased moisture-blocking capabilities to the sealant 450. A water vapor transmission rate of the first spacer 470 can be less than a water vapor transmission rate of the epoxy 460. For example, the water vapor transmission rate of the epoxy 460 can be less than about 0.05 g/m²/day at 60° C. and 90% relative humidity across a 1 mm membrane, such as less than about 10⁻⁵ g/m²/day at 60° C. and 90% relative humidity across a 1 mm membrane.

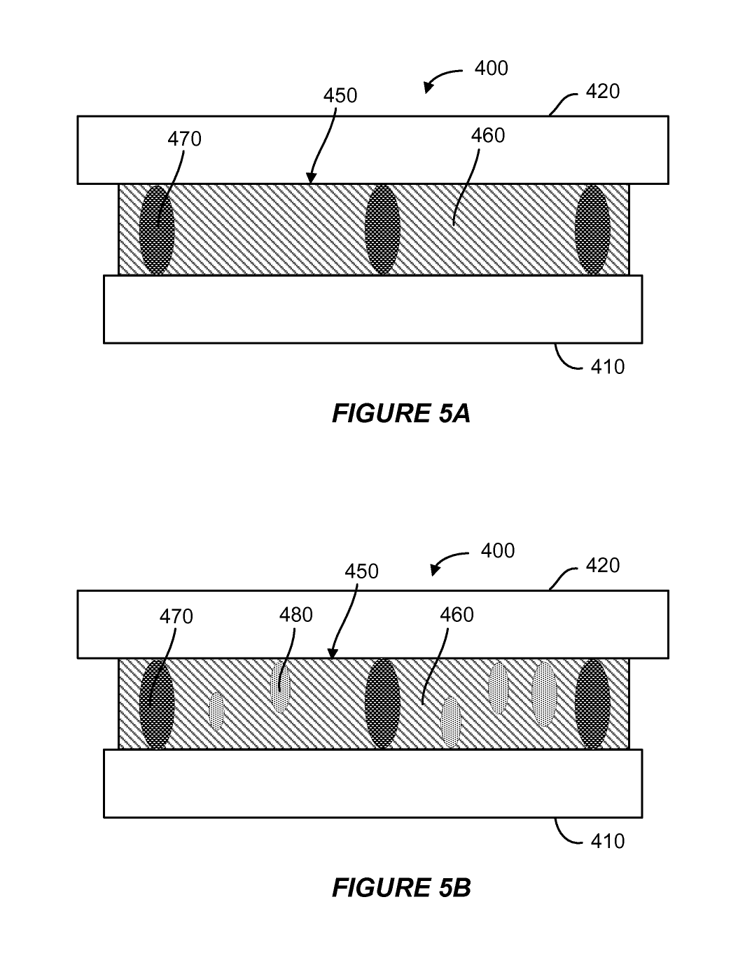

FIG. 5A shows a cross-sectional view along line B-B of FIG. 3A for the example display device, the cross-sectional view showing the sealant including spacers of the same size. As illustrated in FIG. 5A, the sealant 450 can include a plurality of first spacers 470 in the epoxy 460, where the first spacers 470 can define the gap between the substrates 410 and 420. The size of the first spacers 470 can be substantially uniform, so that the size of the first spacers 470 may be within a tolerance of about 0.05 μm or less. The size of the first spacers 470 may refer to the height or diameter of the shape of the spacer 470. This can be measured with reference to a direction transverse to the surface of the substrates 410 and 420. In some implementations, the size of the first spacers 470 may be between about 5 μm and about 25 μm, such as between about 10 μm and about 20 μm. In some implementations, the composition of the first spacers 470 may be identical or include the same material(s). Thus, the size and composition of the spacers 470 may be identical or at least substantially similar.

Since the sealant 450 is provided along the perimeter of the display device 400, the first spacers 470 may be provided along the perimeter of the display device 400. Accordingly, the first spacers 470 may be positioned around the display region 405 of the display device 400. Bumps or other spacer elements (not shown) may be placed within the display region 405 between display elements and between the substrates 410 and 420. Such bumps or display elements may maintain the separation distance between the substrates 410 and 420 in the display region 405. In some implementations, the first spacers 470 may be evenly distributed or substantially evenly distributed in the epoxy 460 of the sealant 450 by weight percent using double rotation (self/centrifugal) method with defoaming mixer. In some implementations, the density of the first spacers 470 is between about 0.1 wt. % and about 1.5 wt. % of the sealant 450. As shown in Table I below, a sealant made of a 1 mm-wide epoxy-based adhesive without any spacers has a water vapor transmission rate of 36.0 g/m²/day as measured at 60° C. and 90% relative humidity. Adding 1 wt. % of silica spacers with a size or height of 16 μm to the sealant lowers the water vapor transmission rate by about 3% to 34.8 g/m²/day at 60° C. and 90% relative humidity.

The density of the first spacers 470 may be controlled to balance improvements against moisture ingress to the sealant 450 while minimizing adverse effects to the mechanical strength or adhesion of the sealant 450. If the density of the first spacers 470 is too high, then more contact points can be made with a surface of either of the first substrate 410 or the second substrate 420, thereby adversely affecting the adhesion strength of the sealant 450. Moreover, if the density of the first spacers 470 is too high, then the viscosity of the epoxy 460 may be increased, which may make dispensing the epoxy more difficult. However, if the density of the first spacers 470 is too low, then there may not be sufficient reductions to the water vapor transmission rate of the sealant 450 to improve device reliability.

FIG. 5B shows a cross-sectional view along line B-B of FIG. 3A for the example display device, the cross-sectional view showing the sealant including spacers of different sizes. Second spacers 480 have an average size or diameter less than the first spacers 470 may be added to the sealant 450 to improve moisture-blocking capabilities of the sealant 450. The second spacers 480 may be mixed with the epoxy 460.

The epoxy 460 may form a matrix for which the second spacers 480 are distributed therein. In some implementations, the epoxy 460 may form a matrix for which the first spacers 470 and the second spacers 480 are distributed therein. In some implementations, the second spacers 480 may be randomly distributed or substantially randomly distributed in the epoxy 460 of the sealant 450. In some implementations, the density of the second spacers is between about 0.5 wt. % and about 5.0 wt. % of the sealant 450, such as between about 1.0 wt. % and about 2.0 wt. % of the sealant 450. As shown in Table I below, adding 1 wt. % of 10 μm silica spacers in addition to 1 wt. % of 16 μm silica spacers to the sealant lowers the water vapor transmission rate to about 33.2 g/m²/day at 60° C. and 90% relative humidity. This is about 6% reduction in the water vapor transmission rate compared to the 1 mm-wide epoxy-based adhesive without any spacers. Alternatively, adding 5 wt. % of 10 μm silica spacers in addition to 1 wt. % of 16 μm silica spacers to the sealant further reduces the water vapor transmission rate to about 21.9 g/m²/day at 60° C. and 90% relative humidity. This is about 39% reduction in the water vapor transmission rate compared to the 1 mm-wide epoxy-based adhesive without any spacers.

The second spacers 480 can be made of a plastic, glass, ceramic or other material. In some implementations, the second spacers 480 can be include an inorganic material, such as silica, silicon, metal, metal oxide or diamond. For example, the plurality of second spacers can be made of one or more of: silica (SiO₂), silicon, silver (Ag), gold (Au), platinum (Pt), titanium (Ti), alumina (Al₂O₃), titanium oxide (TiO₂) and diamond. In some implementations, the second spacers 480 can include an organic material, such as a cross-linked polymer. Increased cross-linking in a polymer for the second spacer 480 can provide greater density to reduce moisture ingress through the sealant 450. In some implementations, the second spacers 480 can be made of the same material as the first spacers 470.

The material of the second spacers 480 has a lower water vapor transmission rate than the epoxy 460. In some implementations, the material of the second spacers 480 has a water vapor transmission rate of less than about 0.05 g/m²/day at 60° C. and 90% relative humidity across a 1 mm membrane, such as less than about 10⁻⁵ g/m²/day 60° C. and 90% relative humidity across a 1 mm membrane. The material of the second spacers 480 may be compatible with the epoxy 460. Incompatible materials may lead to voids and reduce the adhesiveness of the sealant 450. This can cause delamination of the sealant 450 from the substrates 410 and 420 and can make the water vapor transmission rate even worse. Thus, the material of the second spacers 480 can be highly impermeable to water vapor and can mix effectively with the epoxy 460.

First, a compatible material with the epoxy 460 can include materials that have strong adhesion with the epoxy 460. This can include an inorganic material that is known to adhere to the epoxy 460 or any material that can have its surface functionalized to achieve relatively strong adhesion with the epoxy 460. Second, a compatible material with the epoxy 460 can include materials that do not chemically react with the epoxy 460 or its outgassing species. Outgassing species can include, for example, residual catalyst, unreacted thermal acid generator (TAG), unreacted photo acid generator (PAG), etc. Third, the material does not react with water or dissolve in water at temperatures equal to or less than about 60° C. Examples of compatible inorganic materials with the epoxy 460 can include quartz, glass, single crystalline silicon (mono-Si), polysilicon (poly-Si), amorphous silicon (a-Si), silica (SiO₂), silver (Ag), gold (Au), platinum (Pt), aluminum (Al), titanium (Ti), alumina (Al₂O₃), titanium oxide (TiO₂) and diamond. Examples of compatible organic materials with the epoxy 460 can include cross-linked polymers that are miscible with the epoxy 460 or otherwise surface-functionalized (such as coated with nitride) to have good adhesion with the epoxy 460, and have higher cross-linking density and higher density than the epoxy 460.

The second spacers 480 can have an average size that is less than the first spacers 470. As illustrated in FIG. 5B, the first spacers 470 can establish a separation or gap between the two substrates 410 and 420, where a size of the first spacers 470 can be between about 5 μm and about 25 μm, such as between about 10 μm and about 20 μm. However, the second spacers 480 do not establish a separation or gap between the two substrates 410 and 420. In some implementations, an average size of the second spacers 480 can be between about 5 μm and about 15 μm, such as between about 8 μm and about 12 μm. Without defining the separation or gap between the substrates 410 and 420, the size of the second spacers 480 is substantial enough to reduce moisture ingress through the sealant 450. The size and distribution of the second spacers 480 can create a tortuous and circuitous pathway for moisture to travel through the sealant 450, thereby improving the moisture-blocking capabilities of the sealant 450. As more smaller-sized second spacers 480 are added to fill the space between the bigger-sized first spacers 470, the water vapor transmission rate of the sealant 450 can be reduced and approach zero.

Table I summarizes the simulated data for the water vapor transmission rates of various sealants at 60° C. and 90% relative humidity, where the sealants include an epoxy-based adhesive having a width of 1 mm, a height of 16 μm, a length of 10 mm and an area of 0.16 mm². The epoxy-based adhesive has a water vapor transmission rate of 36.0 g/m²/day without any spacers. Introducing spacers of different sizes can reduce the effective area of the sealant, and thereby lower the water vapor transmission rate of the sealant.

TABLE I

| | Moisture after | Water Vapor |
|---|---|---|
| | 24 hours | Transmission Rate |
| Epoxy Seal | (g) | (g/m²/day) |
| Sealant with no spacer | 5.76 × 10⁻⁶ | 36.0 |
| Sealant with 16 μm-diameter | 5.57 × 10⁻⁶ | 34.8 |
| spacers (1 wt. %) | | |
| Sealant with 16 μm-diameter | 5.31 × 10⁻⁶ | 33.2 |
| spacers (1 wt. %) and 10 μm- | | |
| diameter spacers (1 wt. %) | | |
| Sealant with 16 μm-diameter | 3.50 × 10⁻⁶ | 21.9 |
| spacers (1 wt. %) and 10 μm- | | |
| diameter spacers (5 wt. %) | | |

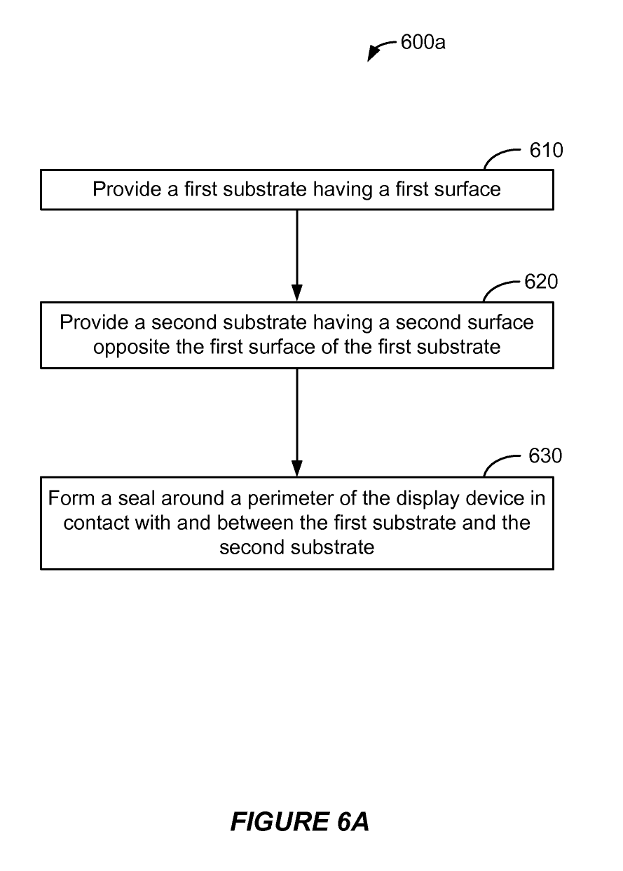

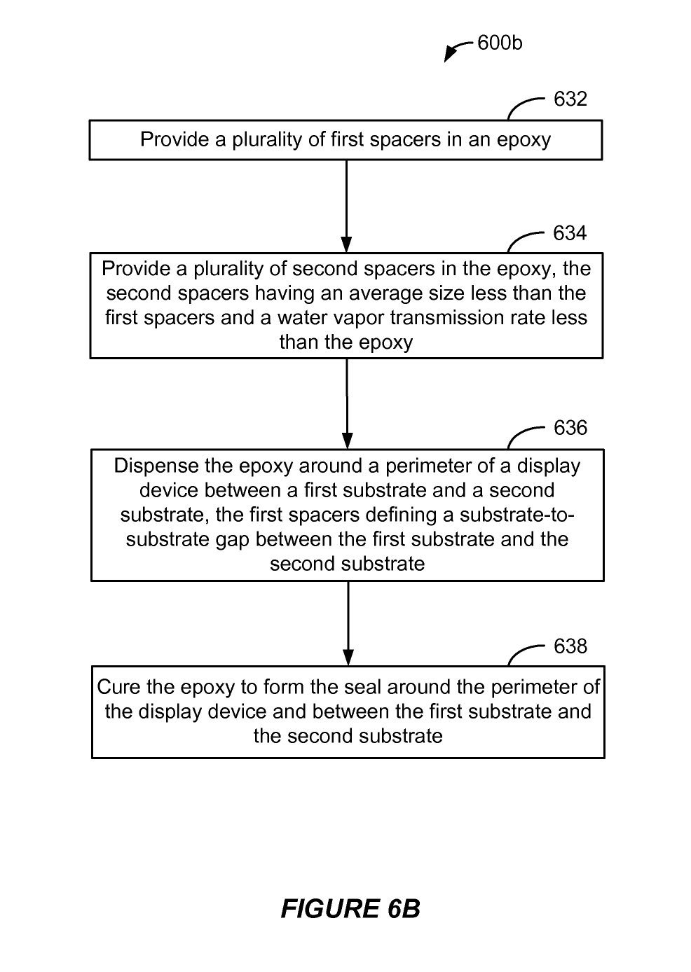

FIG. 6A shows a flow diagram illustrating an example process for manufacturing a display device. The process 600a may be performed in different orders and/or with different, fewer or additional operations. In some implementations, the process 600a may be described with reference to an EMS or MEMS display device.

At block 610 of the process 600a, a first substrate having a first surface is provided. The first substrate can be made of any substrate material, such as glass or plastic. In some implementations, the first substrate may be an aperture plate. In some implementations, a display element is provided on the first surface of the first substrate. The display element may be part of an array of display elements on the first substrate, where the display elements may include EMS or MEMS-based display elements. Examples of MEMS-based display elements can include IMODs and shutter-based light modulators.

The process 600a continues at block 620, where a second substrate having a second surface opposite the first surface of the first substrate is provided. The second substrate can be made of any substrate material, such as glass or plastic. In some implementations, the second substrate may be a back plate. The second substrate may be aligned with the first substrate. In some implementations, the second substrate may be positioned over the display element.

The process 600a continues at block 630 where a seal is formed around a perimeter of the display device in contact with and between the first substrate and the second substrate. The seal can enclose the display element in the display device. The seal can include an epoxy. The seal can further include a plurality of first spacers defining a substrate-to-substrate gap between the first substrate and the second substrate. The seal can further include a plurality of second spacers in the epoxy and having an average diameter less than the first spacers and having a water vapor transmission rate less than the epoxy. The water vapor transmission rate of the second spacers may be relatively close to zero, such as less than about 10⁻⁵ g/m²/day across a 1 mm thick membrane at 60° C. and 90% relative humidity.

FIG. 6B shows another flow diagram illustrating an example process for forming a seal around a perimeter of a display device. The process 600b may be performed in different orders and/or with different, fewer or additional operations. The process 600b may be described with reference to the seal formed around the perimeter of the display device in the process 600a of FIG. 6A.

At block 632 of the process 600b, a plurality of first spacers is provided in an epoxy. The first spacers may be mixed with the epoxy before dispensing the epoxy around the perimeter of the display device. In some implementations, the first spacers may be mixed with the epoxy after the epoxy is dispensed around the perimeter of the display device. In some implementations, the density of the first spacers can be between about 0.1 wt. % and about 1.5 wt. % of the epoxy. In some implementations, a size or diameter of the first spacers may be between about 5 μm and about 25 μm, or between about 10 μm and about 20 μm.

At block 634 of the process 600b, a plurality of second spacers is provided in the epoxy. The second spacers have an average a size less than the first spacers and a water vapor transmission rate less than the epoxy. The plurality of second spacers in the epoxy may each be smaller than the first spacers and have a water vapor transmission rate less than the epoxy. The second spacers may be mixed with the epoxy before the epoxy is dispensed or after the epoxy is dispensed. In some implementations, the density of the second spacers can be between about 0.5 wt. % and about 5.0 wt. % of the epoxy. In some implementations, the average size or diameter of the second spacers may be between about 5 μm and about 15 μm, or between about 8 μm and about 12 μm. In some implementations, the plurality of second spacers are made of one or more of: silica (SiO₂), silicon (Si), silver (Ag), gold (Au), platinum (Pt), titanium (Ti), alumina (Al₂O₃), titanium oxide (TiO₂) and diamond.

At block 636 of the process 600b, the epoxy is dispensed around a perimeter of a display device between a first substrate and a second substrate. In some implementations, the epoxy can be dispensed in a liquid or semi-liquid state between the first substrate and the second substrate. Dispensing the epoxy can include but is not limited to casting, injection molding, masking and spraying or printing. In some examples, dispensing can be achieved using a syringe. In some implementations, the first spacers and the second spacers may be provided in the epoxy after the epoxy is dispensed.

At block 638 of the process 600b, the epoxy can be cured to form the seal around the perimeter of the display device and between the first substrate and the second substrate. The seal can enclose the display element in the display device. Curing the epoxy can include but is not limited to a thermal cure, a time-based cure, a radiation cure such as a UV cure, a moisture cure or air (oxygen) dry.

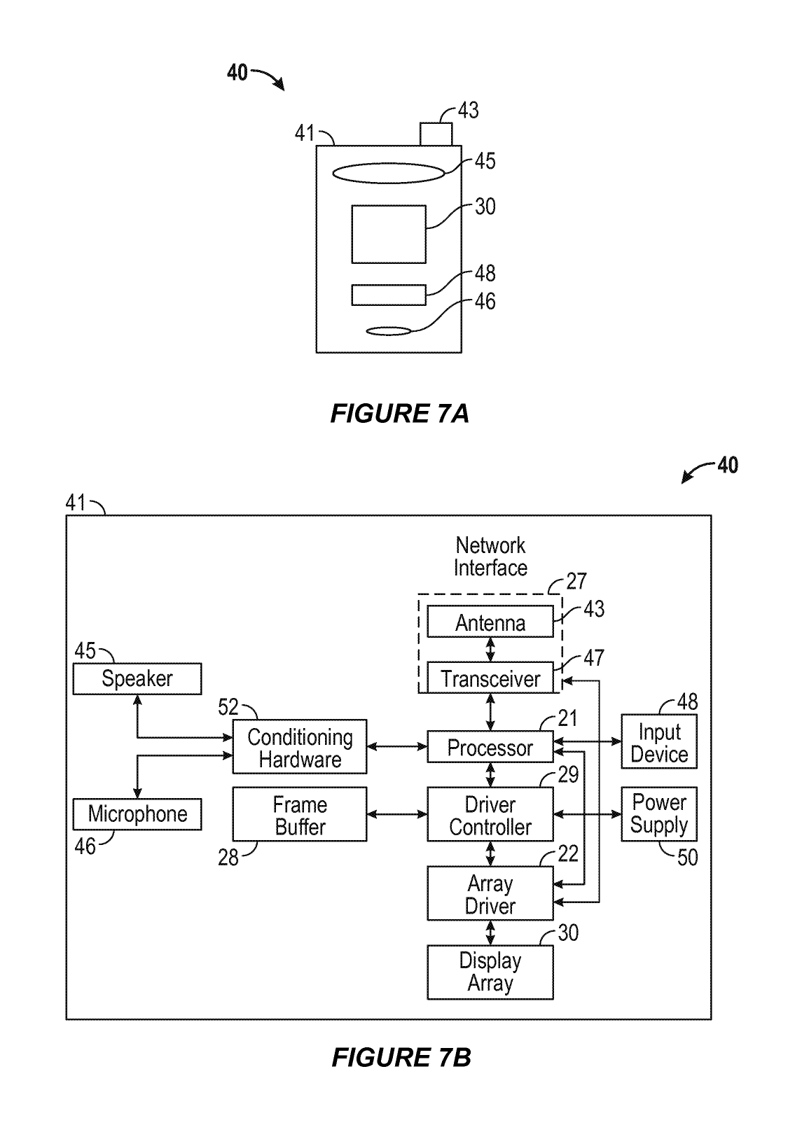

FIGS. 7A and 7B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices. The display device 40 may include an epoxy-based adhesive to seal the display elements, where the epoxy-based adhesive can include first spacers and second spacers as described earlier herein.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 7B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 7A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device, comprising:
a first substrate having a first surface;
a second substrate having a second surface opposite the first surface of the first substrate; and
a sealant positioned around the perimeter of the display device and in contact with and between the first substrate and the second substrate, the sealant including:
an epoxy;
a plurality of first spacers inside the epoxy and having a size defining a substrate-to-substrate gap between the first substrate and the second substrate; and
a plurality of second spacers inside the epoxy and having an average size less than the size of the first spacers, wherein the second spacers have a water vapor transmission rate less than the epoxy.

2. The device of claim 1, wherein the density of the plurality of second spacers is between about 0.5 wt. % and about 5.0 wt. % in the sealant.

3. The device of claim 1, wherein the density of the plurality of first spacers is between about 0.1 wt. % and about 1.5 wt. % in the sealant.

4. The device of claim 1, wherein the plurality of second spacers are made of one or more of: silica (SiO₂), silicon (Si), silver (Ag), gold (Au), platinum (Pt), titanium (Ti), alumina (Al₂O₃), titanium oxide (TiO₂) and diamond.

5. The device of claim 4, wherein the plurality of second spacers include silica.

6. The device of claim 1, wherein the plurality of second spacers include a cross-linked polymer.

7. The device of claim 1, wherein the first spacers are made of the same material as the second spacers.

8. The device of claim 1, wherein the second spacers have a water vapor transmission rate of less than about 0.05 g/m²/day across a 1 mm membrane at 60° C. and 90% relative humidity.

9. The device of claim 1, wherein the sealant has a water vapor transmission rate of less than about 34 g/m²/day across a 1 mm membrane at 60° C. and 90% relative humidity.

10. The device of claim 1, wherein the first spacers are substantially evenly distributed within the epoxy, and wherein the second spacers are substantially randomly distributed within the epoxy.

11. The device of claim 1, wherein the substrate-to-substrate gap between the first substrate and the second substrate is between about 12 μm and about 16 μm.

12. The device of claim 1, wherein the average size of the second spacers is between about 5 μm and about 15 μm.

13. The device of claim 1, further comprising:
a display element disposed on the first surface of the first substrate, wherein the sealant encloses the display element.

14. The device of claim 13, wherein the display element includes a shutter-based light modulator.

15. The device of claim 13, further comprising:
a processor capable of communicating with the display element, the processor being capable of processing image data; and
a memory device capable of communicating with the processor.

16. The device of claim 15, further comprising:
a driver circuit capable of sending at least one signal to the display element; and
a controller capable of sending at least a portion of the image data to the driver circuit.

17. The device of claim 15, further comprising:
an image source module capable of sending the image data to the processor, wherein the image source module includes at least one of a receiver, transceiver, and transmitter.

18. The device of claim 15, further comprising:
an input device capable of receiving input data and communicating the input data to the processor.

19. A display device, comprising:
a first substrate having a first surface;
a second substrate having a second surface opposite the first surface of the first substrate; and
means for sealing the display device positioned around the perimeter of the display device and in contact with and between the first substrate and the second substrate, sealing means including:
an epoxy;
means for defining a substrate-to-substrate gap between the first substrate and the second substrate inside the epoxy; and
means for reducing moisture ingress inside the epoxy, wherein the moisture ingress reducing means have an average size less than the substrate-to-substrate gap defining means, and wherein the moisture ingress reducing means have a water vapor transmission rate less than the epoxy.

20. The device of claim 19, wherein the density of the moisture ingress reducing means is between about 0.5 wt. % and about 5.0 wt. % in the sealing means.

21. The device of claim 19, wherein the density of the substrate-to-substrate gap defining means is between about 0.1 wt. % and about 1.5 wt. % in the sealing means.

22. The device of claim 19, wherein the moisture ingress reducing means is made of one or more of: silica (SiO₂), silicon (Si), silver (Ag), gold (Au), platinum (Pt), titanium (Ti), alumina (Al₂O₃), titanium oxide (TiO₂) and diamond.

23. The device of claim 19, wherein the substrate-to-substrate gap defining means are substantially evenly distributed within the epoxy, and wherein the moisture ingress reducing means are substantially randomly distributed within the epoxy.

24. The device of claim 19, wherein the average size of the moisture ingress reducing means is between about 5 μm and about 15 μm.

25. A method of manufacturing a display device, comprising:
providing a first substrate having a first surface;
providing a second substrate having a second surface opposite the first surface of the first substrate; and
forming a seal around a perimeter of the display device in contact with and between the first substrate and the second substrate, wherein the seal includes an epoxy, a plurality of first spacers in the epoxy defining a substrate-to-substrate gap between the first substrate and the second substrate, and a plurality of second spacers in the epoxy each being smaller than the first spacers and having a water vapor transmission rate less than the epoxy.

26. The method of claim 25, further comprising:
providing a display element on the first surface of the first substrate, wherein the seal encloses the display element.

27. The method of claim 26, wherein the display element includes a shutter-based light modulator.

28. The method of claim 25, further comprising:
mixing the first spacers and the second spacers into the epoxy before forming the seal around the perimeter of the display device.

29. The method of claim 25, wherein the density of the plurality of second spacers is between about 0.5 wt. % and about 5.0 wt. % in the seal.

30. The method of claim 25, wherein the plurality of second spacers are made of one or more of: silica (SiO₂), silicon (Si), silver (Ag), gold (Au), platinum (Pt), titanium (Ti), alumina (Al₂O₃), titanium oxide (TiO₂) and diamond.
